(19) United States
(12) Patent Application Publication
(10) Pub. No.: US 2026/0341276 A1
(43) Pub. Date: Oct. 29, 2026

(54) AUTO REPLY DEVICE, AUTO REPLY METHOD, AND COMPUTER PROGRAM FOR AUTO REPLY

(71) Applicant: TOYOTA JIDOSHA KABUSHIKI KAISHA, Toyota-shi (JP)

(72) Inventors: Masateru UDATE, Tokyo-to (JP); Yuta Tsuzuki, Tokyo-to (JP)

(73) Assignee: TOYOTA JIDOSHA KABUSHIKI KAISHA, Toyota-shi (JP)

(21) Appl. No.: 19/270,894

(22) Filed: Jul. 16, 2025

(30) Foreign Application Priority Data
Sep. 15, 2024 (JP) 2024-161215

(51) Int. Cl. G10L 15/22; G06V 20/59

(52) U.S. Cl. CPC G10L 15/22; G06V 20/597

(57) ABSTRACT

An auto reply device includes a processor configured to estimate a feeling of each of the occupants of a vehicle, based on an interior sensor signal obtained by a vehicle interior sensor configured to sense a condition of the interior of the vehicle, and generate reply information to an utterance of one of the occupants by inputting an estimation of the feeling of each occupant and voice information representing the utterance into a generation model that is pre-trained to generate the reply information.

### FIELD

The present invention relates to an auto reply device that automatically replies to an utterance of an occupant of a vehicle, an auto reply method, and a computer program for auto reply.

### BACKGROUND

A technique of controlling a vehicle appropriately according to the feeling of an occupant of the vehicle other than a driver has been proposed (see Japanese Unexamined Patent Publication JP2024-84568A). A vehicle controller disclosed in JP2024-84568A determines whether a passenger in a vehicle other than a driver feels uncomfortable, and executes vehicle control, based on the passenger's preference data, when the passenger is determined as feeling uncomfortable. When the passenger's preference data does not exist, the vehicle controller executes a monitoring process that is a combination of vehicle control and feeling determination, and acquires the passenger's preference data, based on the result of the monitoring process.

### SUMMARY

Research has been carried out into Large Language Models (LLMs) which automatically generate a reply to a question. Unfortunately, since only text data representing a question is inputted into a LLM, the feeling of a user asking the question is not reflected in a generated reply.

It is an object of the present invention to provide an auto reply device that can reply to an utterance of an occupant in a vehicle so as to reflect the occupant's feeling.

According to an embodiment, an auto reply device is provided which includes a processor configured to: estimate a feeling of each of occupants of a vehicle, based on an interior sensor signal obtained by a vehicle interior sensor configured to sense a condition of the interior of the vehicle, and generate reply information to an utterance of one of the occupants by inputting an estimation of the feeling of each occupant and voice information representing the utterance into a generation model that is pre-trained to generate the reply information.

In an embodiment, the processor generates the reply information by inputting, for each occupant, an estimation of the feeling of the occupant into the generation model, together with position information indicating the position of the occupant.

In an embodiment, the processor is further configured to store a combination of the reply information, an estimation of the feeling of each occupant and the voice information inputted into the generation model at generation of the reply information in a memory, every time the reply information is generated. The processor generates the reply information by further inputting the combination stored in the memory in a most recent predetermined period into the generation model.

According to another embodiment, an auto reply method is provided. The auto reply method includes estimating a feeling of each of occupants of a vehicle, based on an interior sensor signal obtained by a vehicle interior sensor configured to sense a condition of the interior of the vehicle; and generating reply information to an utterance of one of the occupants by inputting an estimation of the feeling of each occupant and voice information representing the utterance into a generation model that is pre-trained to generate the reply information.

According to still another embodiment, a non-transitory recording medium that stores a computer program for auto reply is provided. The computer program includes instructions causing a computer to execute a process including estimating a feeling of each of occupants of a vehicle, based on an interior sensor signal obtained by a vehicle interior sensor configured to sense a condition of the interior of the vehicle; and generating reply information to an utterance of one of the occupants by inputting an estimation of the feeling of each occupant and voice information representing the utterance into a generation model that is pre-trained to generate the reply information.

The auto reply device of the present disclosure has an advantageous effect of being able to reply to an utterance of an occupant in a vehicle so as to reflect the occupant's feeling.

### BRIEF DESCRIPTION OF DRAWINGS

FIG. 1 schematically illustrates the configuration of a vehicle equipped with an auto reply device.

FIG. 2 illustrates the hardware configuration of the auto reply device.

FIG. 3 is a functional block diagram of a processor of the auto reply device.

FIG. 4 illustrates the relationship between input into a generation model and reply information of the embodiment.

FIG. 5 is an operation flowchart of the auto reply device.

FIG. 6 is a functional block diagram of the processor of the auto reply device of a modified example.

FIG. 7 is an operation flowchart of the auto reply device of the modified example.

### DESCRIPTION OF EMBODIMENTS

An auto reply device as well as an auto reply method and a computer program for auto reply executed by the auto reply device will now be described with reference to the attached drawings. The auto reply device estimates a feeling of each of occupants of a vehicle, and generates reply information to an utterance of one of the occupants by inputting an estimation of the feeling of each occupant and voice information representing the utterance into a generation model that is pre-trained to generate the reply information.

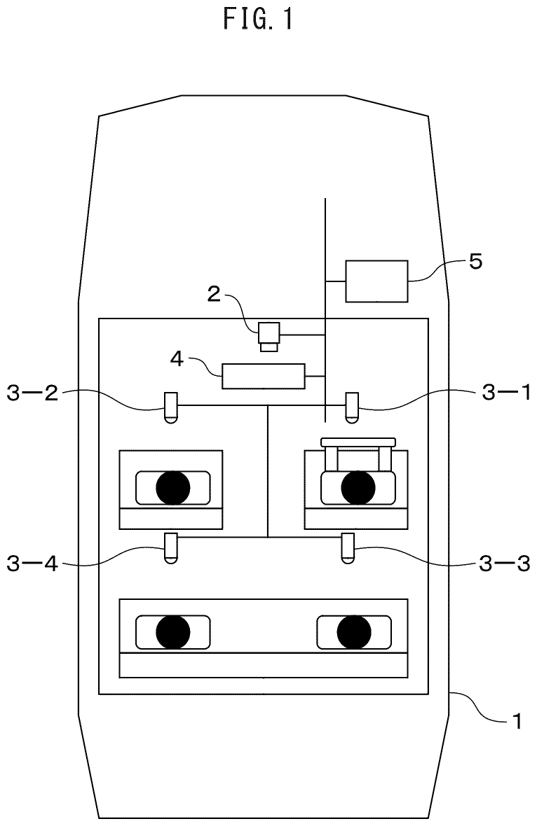

FIG. 1 schematically illustrates the configuration of a vehicle equipped with an auto reply device. In the present embodiment, the vehicle 1 includes a camera 2, multiple microphones 3-1 to 3-n (n is an integer of 2 or more and is four in the illustrated example), a notification device 4, and an auto reply device 5. The camera 2, the microphones 3-1 to 3-n, and the notification device 4 are communicably connected to the auto reply device 5.

The camera 2, which is an example of the vehicle interior sensor, is installed near the top of the windshield and oriented to the vehicle interior so that all the occupants in the vehicle 1 are included in the region to be captured by the camera. Every predetermined capturing period, the camera 2 generates an image representing the interior of the vehicle 1 and outputs the generated image to the auto reply device 5. An image generated by the camera 2 will be referred to as an “interior image,” below. An interior image is an example of the interior sensor signal.

The microphones 3-1 to 3-n, each of which is another example of the vehicle interior sensor, pick up a voice of an occupant in the vehicle 1 and outputs a voice signal representing the voice. To achieve this, for each seat of the vehicle 1, one of the microphones 3-1 to 3-n is installed at a position where a voice of an occupant sitting on the seat can be picked up. In the example illustrated in FIG. 1, the microphones are installed near the driver's seat, the passenger seat, the right rear seat, and the left rear seat, respectively (for example, those of the driver's seat and the passenger seat are on an instrument panel, and those of the rear seats are on the backs of the front seats). The microphones 3-1 to 3-n may be arrayed at positions where a voice of any occupant in the vehicle interior can be picked up (e.g., near the ceiling of the front of the vehicle interior or on the instrument panel). The microphones 3-1 to 3-n each output a generated voice signal to the auto reply device 5. Each of voice signals generated by the individual microphones is another example of the interior sensor signal.

The notification device 4 is provided in the interior of the vehicle 1 and notifies an occupant of a reply represented by reply information generated by the auto reply device 5. To achieve this, the notification device 4 includes, for example, at least one of a speaker or a display. When a notification signal representing a reply to an occupant is received from the auto reply device 5, the notification device 4 notifies the occupant of the reply by a voice from the speaker or by displaying a message, an image, or a video on the display. For each seat, a display or a speaker included in the notification device 4 may be installed and oriented to an occupant sitting on the seat.

The auto reply device 5 generates reply information to an utterance of an occupant of the vehicle 1, and notifies the generated reply information to the occupant of the vehicle 1 via the notification device 4 or controls the vehicle 1 itself or a device mounted on the vehicle 1 according to the reply information.

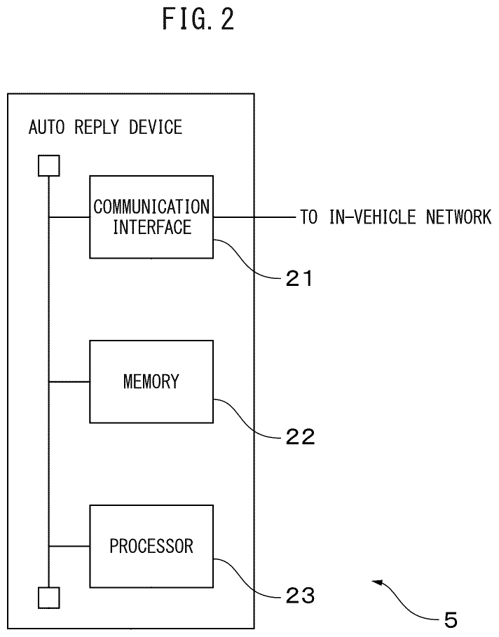

FIG. 2 illustrates the hardware configuration of the auto reply device 5. As illustrated in FIG. 2, the auto reply device 5 includes a communication interface 21, a memory 22, and a processor 23. The communication interface 21, the memory 22, and the processor 23 may be configured as separate circuits or a single integrated circuit.

The communication interface 21 includes an interface circuit for connecting the auto reply device 5 to another device inside the vehicle. The communication interface 21 passes an interior image received from the camera 2 and voice signals received from the microphones 3-1 to 3-n to the processor 23. The communication interface 21 outputs a notification signal received from the processor 23 to the notification device 4 or a control command received from the processor 23 to a vehicle-mounted device.

The memory 22, which is an example of the storage unit, includes, for example, volatile and nonvolatile semiconductor memories, and stores various types of data used in an auto reply process executed by the processor 23. More specifically, the memory 22 stores parameters specifying a generation model for generating reply information. In addition, the memory 22 may temporarily store interior images received from the camera 2 and voice signals received from the microphones 3-1 to 3-n.

The processor 23 includes one or more central processing units (CPUs) and a peripheral circuit thereof. The processor 23 may further include another operating circuit, such as a logic-arithmetic unit, an arithmetic unit, or a graphics processing unit. The processor 23 executes an auto reply process.

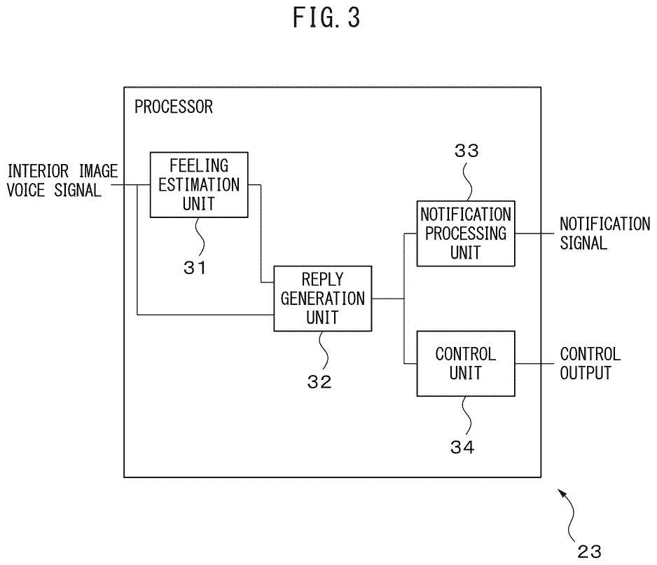

FIG. 3 is a functional block diagram of the processor 23, related to the auto reply process. The processor 23 includes a feeling estimation unit 31, a reply generation unit 32, a notification processing unit 33, and a control unit 34. These units included in the processor 23 are, for example, functional modules implemented by a computer program executed by the processor 23, or may be dedicated operating circuits provided in the processor 23.

The feeling estimation unit 31 estimates a feeling of each of occupants in the vehicle 1. To achieve this, for each occupant, the feeling estimation unit 31 detects a sub-region representing the occupant in an interior image by inputting the interior image into a classifier that is pre-trained to detect an occupant. The classifier for occupant detection is configured as a DNN having architecture of a convolutional neural network (CNN) type, such as Single Shot MultiBox Detector, or a DNN having an attention mechanism, such as Vision transformer. Alternatively, the classifier for occupant detection may be configured as a classifier based on a machine learning technique other than a DNN, such as an AdaBoost classifier.

The feeling estimation unit 31 estimates the feeling of each occupant by inputting, for each occupant, a sub-region representing the occupant into a feeling estimator that is pre-trained to estimate a feeling. The feeling estimator is configured, for example, as a CNN including convolution layers, one or more fully-connected layers, and an output layer in the order from the input side. The output layer calculates confidence scores of respective types of feeling (e.g., pleasure, anger, sadness, surprise, anxiety, and neutral) by a softmax operation.

The feeling estimation unit 31 may estimate the feeling of each occupant in accordance with another feeling estimation technique. For example, the feeling estimation unit 31 may detect feature points of an occupant's face (e.g., multiple points on the outlines of the eyes, nose, and mouth) from a sub-region representing the occupant, and inputs the individual feature points into a feeling estimator that estimates a feeling based on detected individual feature points, thereby estimating the occupant's feeling. In this case, the feeling estimation unit 31 detects individual facial feature points by applying a feature point detector based on an active shape model (ASM) or active appearance models (AAM) to a sub-region representing an occupant. The feeling estimator is configured as a DNN or a support vector machine (SVM).

Alternatively, the feeling estimation unit 31 may estimate the feeling of each occupant, based on voice signals generated by the microphones 3-1 to 3-n. In this case, the feeling estimation unit 31 inputs a voice signal whose average volume in a most recent predetermined period is not less than a predetermined threshold into a feeling estimator that estimates a feeling, based on a voice signal, thereby estimating the feeling of an occupant at the position of a microphone generating the voice signal. In this case, the feeling estimator is configured as a DNN having a recursive structure, such as a recurrent neural network (RNN) or Long Short-Term Memory (LSTM). Alternatively, the feeling estimator may be configured based on a machine learning technique other than a DNN.

For each occupant, the feeling estimation unit 31 generates a feeling vector representing an estimation of the feeling of the occupant. A feeling vector has element values that are confidence scores of respective types of feeling. For example, assume that a feeling vector has individual element values indicating confidence scores of pleasure, anger, sadness, surprise, anxiety, and neutral in the order, and that the confidence scores of pleasure, anger, sadness, surprise, anxiety, and neutral as an estimation of an occupant's feeling are 0.6, 0.02, 0.03, 0.1, 0.05, and 0.2, respectively. In this case, the feeling vector is (0.6, 0.02, 0.03, 0.1, 0.05, 0.2).

In addition, the feeling estimation unit 31 identifies the position of each occupant. For example, reference points in an interior image corresponding to the positions of the individual seats in the vehicle interior are pre-stored in the memory 22. For each occupant detected from an interior image, the feeling estimation unit 31 identifies a reference point closest to the centroid of a sub-region representing the occupant, and identifies the position of a seat corresponding to the identified reference point as the occupant's position. As the position of an occupant whose feeling is estimated based on a voice signal, the feeling estimation unit 31 may identify the position of a seat closest to a microphone generating the voice signal among the microphones 3-1 to 3-n. When the microphones 3-1 to 3-n are arrayed, the feeling estimation unit 31 may estimate the direction from which a voice comes, based on the phase differences between voice signals generated by the microphones, and estimate the position of a seat in a direction closest to the direction from which the voice comes as viewed from the microphones to be the occupant's position. In this case, the directions from the installed positions of the microphones to the respective seats may be pre-stored in the memory 22. The feeling estimation unit 31 identifies a seat in the direction closest to the direction from which the voice comes, by referring to the directions to the respective seats pre-stored in the memory 22.

For each occupant, the feeling estimation unit 31 outputs the occupant's feeling vector to the reply generation unit 32, together with position information indicating the occupant's position. The position information includes a character string representing the occupant's position (e.g., a character string representing the occupant's seat, such as “driver's seat” or “passenger seat”) or a vector indicating the occupant's position. When the occupant's position is indicated by a vector, the vector is generated, for example, so that different elements are included for the respective seats and that the value of an element corresponding to the seat where the occupant associated with a feeling estimation is sitting differs from the values of elements corresponding to the other seats.

The reply generation unit 32 generates reply information to an utterance by inputting an estimation of the feeling of each occupant and voice information representing the utterance into a generation model that is pre-trained to generate the reply information.

To generate voice information representing an utterance, the reply generation unit 32 inputs a voice signal whose average volume in a most recent predetermined period exceeds an utterance detection threshold among voice signals generated by the microphones 3-1 to 3-n into a voice recognition model, thereby recognizing an utterance represented by the voice signal, and generates a character string representing the utterance as voice information. Such a voice recognition model is configured, for example, as a DNN having an attention mechanism or a DNN having a recursive structure, such as a RNN or LSTM. Alternatively, the voice recognition model may be configured as a GMM-HMM based on a mixture Gaussian distribution and a hidden Markov model or as a DNN-HMM based on a DNN and a hidden Markov model. The reply generation unit 32 may divide a voice signal into frames each having a predetermined length of time, extract a feature of the voice for each frame, and input the feature of each frame into the voice recognition model in chronological order, thereby recognizing an utterance represented by the voice signal. The feature of each frame may be, for example, a predetermined element of the cepstrum of the frame.

The reply generation unit 32 adds a character string representing the estimation of the feeling of each occupant to the beginning or end of the character string representing the utterance in the voice information, thereby representing a combination of the utterance and the estimation of the feeling of each occupant with a single character string.

In the present embodiment, the generation model is configured as a LLM. The LLM that is the generation model is configured, for example, as one with multiple stacked blocks each including an attention layer and a feed forward layer. The reply generation unit 32 inputs the character string representing the utterance and the estimation of the feeling of each occupant into the LLM. The generation model then outputs text data representing a reply as reply information. Inputting an estimation of the feeling of each occupant, together with voice information representing an utterance, into the generation model in this way enables the generation model to generate reply information representing a reply, taking account of the feeling of each occupant.

Reply information is not limited to information including a reply to be notified to each occupant via the notification device 4, and may include a reply for controlling the vehicle 1 itself or a device mounted on the vehicle 1.

According to a modified example, for each occupant, the reply generation unit 32 may input an estimation of the feeling of the occupant into the generation model, together with position information of the occupant. In this case, for each occupant, the reply generation unit 32 inserts a character string representing the occupant's position (e.g., “driver's seat” or “passenger seat”) into a character string to be inputted into the generation model at the beginning or end of a character string representing an estimation of the feeling of the occupant. Inputting position information into the generation model in this way enables the generation model to reflect the difference in feeling depending on the position of each occupant in reply information.

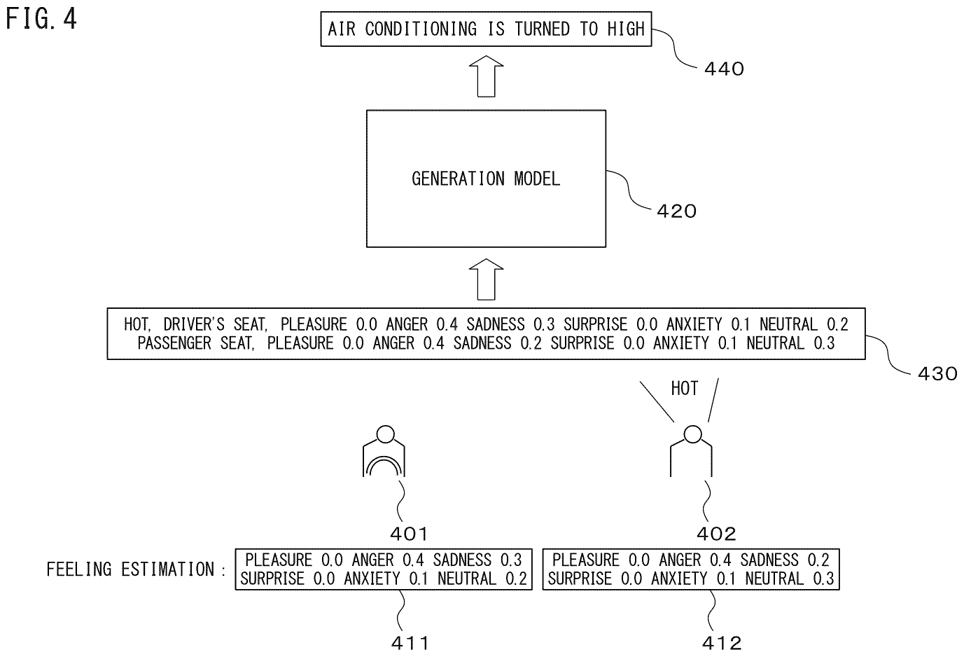

FIG. 4 illustrates the relationship between input into a generation model and reply information of the present embodiment. In the example illustrated in FIG. 4, occupants are sitting on the driver's seat and the passenger seat of the vehicle 1. Thus the feelings of an occupant 401 sitting on the driver's seat, who is a driver, and an occupant 402 sitting on the passenger seat are estimated. An estimation 411 of the feeling of the occupant 401 is “pleasure 0.0 anger 0.4 sadness 0.3 surprise 0.0 anxiety 0.1 neutral 0.2,” and an estimation 412 of the feeling of the occupant 402 is “pleasure 0.0 anger 0.4 sadness 0.2 surprise 0.0 anxiety 0.1 neutral 0.3.”

The occupant 401 or 402 says “Hot.“ In this case, text data 430 to be inputted into a generation model 420 includes the utterance ”Hot,” which is voice information, the occupant's position “driver's seat (passenger seat),” the type of the occupant's feeling, e.g., “pleasure,” and a numerical value of the confidence score of the type. When position information of the occupant is not included in input into the generation model 420, the character string representing the position of each occupant is omitted in the text data 430. By referring to the text data 430, the generation model 420 outputs text data 440 representing a reply to the utterance (“Air conditioning is turned to high”) as reply information.

In the present embodiment, the generation model 420 generates reply information to the utterance by referring to the estimation of the feeling of each occupant. Thus, in the above-described example, the generation model 420 can generate reply information including a reply meaning that air conditioning will be made stronger, to an utterance “Hot,” as the discomfort level of each occupant is higher, i.e., as the confidence scores of negative feelings, such as anger, sadness, and anxiety, are higher. Conversely, when the discomfort level of each occupant is low, i.e., when the confidence scores of negative feelings, such as anger, sadness, and anxiety, is low, the generation model 420 can generate reply information for asking whether to turn air conditioning to high, in response to an utterance “Hot.”

Inputting, for each occupant, an estimation of the feeling of the occupant into the generation model 420, together with position information of the occupant, enables the generation model 420 to generate reply information, taking account of the difference between the feelings of the occupants. For example, when the discomfort level of the occupant 402 sitting on the passenger seat is higher than that of the occupant 401 sitting on the driver's seat, the generation model 420 can generate reply information including a reply meaning that air conditioning will be turned to high on the side of the passenger seat.

According to a modified example, the generation model may include an input layer for inputting a feeling estimation into which a vector representing an estimation of the feeling of each occupant is inputted, separately from the multiple stacked blocks. In this case, only a character string corresponding to voice information is inputted into the block closest to the input side of the multiple stacked blocks, and a vector representing an estimation of the feeling of each occupant is inputted into the input layer for inputting a feeling estimation. The vector representing an estimation of the feeling of each occupant and inputted into the input layer is taken in a block having a cross attention mechanism that calculates cross attention of the vector representing an estimation of the feeling of each occupant and output from an upstream block among the multiple blocks included in the generation model. In this case, a tuning technique such as LoRA may be applied to training of the generation model related to taking in a vector representing an estimation of the feeling of each occupant.

According to another modified example, the generation model may be configured to output reply information for giving notification to an occupant of the vehicle 1 via the notification device 4 and reply information for controlling the vehicle 1 itself or a device mounted on the vehicle 1 separately from each other. In this case, the generation model is configured to include multiple stacked blocks bifurcating in the middle so that one or more blocks for generating reply information for notification and one or more blocks for generating reply information for control are provided in parallel. Each block downstream of the bifurcation is also configured to include an attention layer and a feed forward layer. Reply information for notification and reply information for control are determined separately according to output probabilities calculated by a softmax operation of output from the corresponding last blocks. In this case also, a tuning technique such as LoRA may be applied to training of the generation model related to reply information for notification or reply information for control added to a base model.

The reply generation unit 32 outputs the generated reply information to the notification processing unit 33 and the control unit 34.

The notification processing unit 33 outputs the reply information via the notification device 4. To achieve this, the notification processing unit 33 generates a notification signal representing a reply included in the reply information, and outputs the generated notification signal to the notification device 4 via the communication interface 21. For example, based on the text data representing a reply included in the reply information, the notification processing unit 33 generates a voice signal representing the reply as a notification signal in accordance with a predetermined speech synthesis technique. The notification processing unit 33 then outputs the notification signal to the speaker included in the notification device 4, causing the speaker to output a voice representing the reply. Alternatively, the notification processing unit 33 includes the text data representing a reply in the notification signal, and then causes the text data representing a reply to appear on the display included in the notification device 4.

When the reply information generated by the generation model represents control of a device of the vehicle 1, the processing of the notification processing unit 33 may be omitted.

The control unit 34 controls a device specified by the reply included in the reply information according to the reply. The control unit 34 determines a device to be controlled and a control command by referring to a reference table for control representing the correspondence between text data representing a reply included in reply information, a device to be controlled (including the vehicle 1 itself), and a control command for executing the control. The control unit 34 then outputs the determined control command to an electronic control unit (ECU) of the device to be controlled, via the communication interface 21.

Besides an air conditioner, devices to be controlled may include a window, a door lock, an indoor light, or a seat. As control of a device according to a reply, the control unit 34 opens or closes a window, locks or unlocks a door, turns on or off an indoor light, or adjusts the position of a seat where an occupant is sitting.

When the text data representing a reply does not include any of words that specify a device to be controlled and that are registered in the reference table for control, the reply information is not aimed at controlling a device. Thus, in this case, the control unit 34 does not output a control signal.

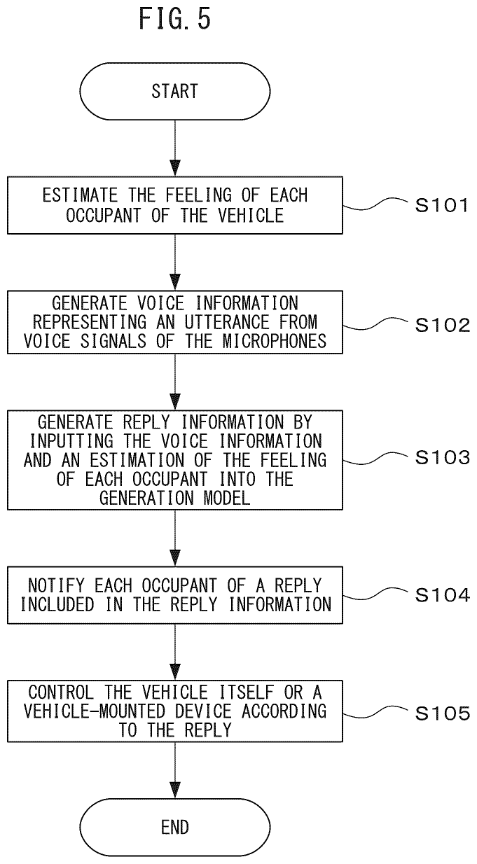

FIG. 5 is an operation flowchart of the auto reply process of the present embodiment. The processor 23 executes the auto reply process in accordance with this operation flowchart.

The feeling estimation unit 31 estimates the feeling of each occupant (step S101). The reply generation unit 32 generates voice information representing an occupant's utterance, based on a voice signal generated by one of the microphones 3-1 to 3-n (step S102). The reply generation unit 32 then generates reply information by inputting the voice information and an estimation of the feeling of each occupant into the generation model (step S103). As described above, for each occupant, the reply generation unit 32 may input an estimation of the feeling of the occupant into the generation model, together with position information of the occupant.

The notification processing unit 33 notifies each occupant of a reply included in the reply information via the notification device 4 (step S104). The control unit 34 controls the vehicle 1 itself or a device mounted on the vehicle 1 according to the reply (step S105).

As has been described above, the auto reply device estimates a feeling of each of occupants of a vehicle, and generates reply information by inputting an estimation of the feeling of each occupant and voice information representing an utterance of one of the occupants into a generation model. The auto reply device can therefore reply to an utterance of an occupant in the vehicle so as to reflect the occupant's feeling.

According to a modified example, the auto reply device 5 may use reply information generated in a most recent predetermined period and a combination of an estimation of the feeling of each occupant and voice information inputted into the generation model at generation of the reply information for generating the latest reply information.

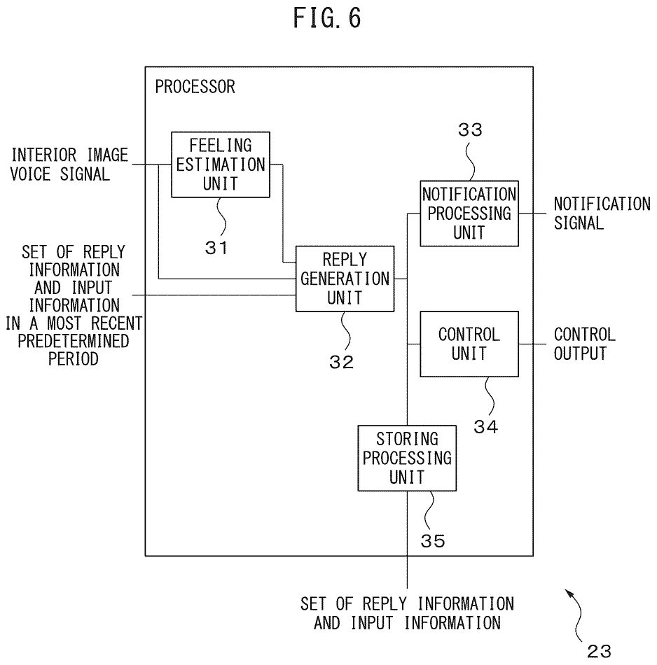

FIG. 6 is a functional block diagram of the processor 23 of the auto reply device 5 of this modified example. The processor 23 includes a feeling estimation unit 31, a reply generation unit 32, a notification processing unit 33, a control unit 34, and a storing processing unit 35. These units included in the processor 23 are, for example, functional modules implemented by a computer program executed by the processor 23, or may be dedicated operating circuits provided in the processor 23. This modified example differs from the above-described embodiment in the storing processing unit 35 included in the processor 23 and part of the processing of the reply generation unit 32. The following describes these differences.

Every time reply information is generated, the storing processing unit 35 stores a combination of the reply information and information inputted into the generation model to generate the reply information (an estimation of the feeling of each occupant and voice information, and position information in the case where position information is further inputted) in the memory 22 in association with the date and time of generation of the reply information. Information inputted into the generation model to generate reply information will be referred to simply as “input information,” below.

When generating reply information, the reply generation unit 32 inputs the above-described combination of reply information and input information in a most recent predetermined period into the generation model, together with an estimation of the feeling of each occupant and voice information. In this modified example also, position information of each occupant may also be inputted into the generation model, together with a feeling estimation, at generation of reply information. The generation model generates reply information by referring to the reply information and the input information in the most recent predetermined period, together with the estimation of the feeling (and the position information) of each occupant and the voice information. In this modified example, the generation model also refers to history of generation of past reply information, and can therefore generate more appropriate reply information.

The reply generation unit 32 represents reply information and input information in the most recent predetermined period with a character string, and joins the character string to a character string representing an estimation of the feeling (and position information) of each occupant and voice information, thereby generating text data to be inputted into the generation model. Alternatively, output of one of those individual blocks in the generation model which include an attention layer and a feed forward layer may be stored in the memory 22 when the generation model generates reply information. Output of the block may be recursively inputted into the block at generation of the next reply information.

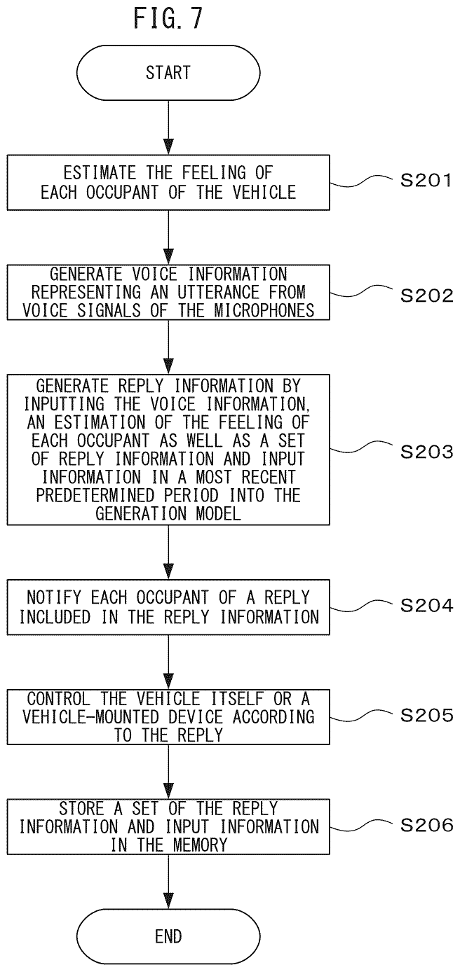

FIG. 7 is an operation flowchart of the auto reply process of this modified example. The processor 23 executes the auto reply process in accordance with this operation flowchart.

The feeling estimation unit 31 estimates the feeling of each occupant (step S201). The reply generation unit 32 generates voice information representing an occupant's utterance, based on a voice signal generated by one of the microphones 3-1 to 3-n (step S202). The reply generation unit 32 then generates reply information by inputting the voice information, an estimation of the feeling of each occupant as well as a combination of reply information and input information in a most recent predetermined period into the generation model (step S203). In this modified example also, for each occupant, the reply generation unit 32 may input an estimation of the feeling of the occupant into the generation model, together with position information of the occupant.

The notification processing unit 33 notifies each occupant of a reply included in the reply information via the notification device 4 (step S204). The control unit 34 controls the vehicle 1 itself or a device mounted on the vehicle 1 according to the reply (step S205). The storing processing unit 35 stores a combination of the reply information and input information inputted into the generation model to generate the reply information, in the memory 22 (step S206).

As has been described above, the auto reply device of this modified example refers to history of past combination of reply information and input information at generation of reply information. The auto reply device can therefore generate more appropriate reply information.

In the above-described embodiment and modified examples, the reply generation unit 32 may further input an interior image or a sub-region representing each occupant in an interior image into the generation model at generation of reply information. In this case, the generation model is configured as a vision language model (VLM). Inputting an interior image or a sub-region representing an occupant in this way enables the generation model to generate reply information by referring to the state of the occupant. When sub-regions representing occupants are inputted into the generation model, the reply generation unit 32 crops, for each occupant, a sub-region representing the occupant from an interior image, or masks the region other than sub-regions representing respective occupants by changing the values of individual pixels included in the region other than the sub-regions to a predetermined pixel value.

In the above-described embodiment or modified examples, the reply generation unit 32 may further input at least one of the following into the generation model at generation of reply information: a sensor signal obtained by a sensor provided for the vehicle 1 to sense motion of the vehicle 1, a sensor signal obtained by a sensor for sensing the condition of the interior of the vehicle 1 or an area around the vehicle 1, the amount of operation of the vehicle 1 by an occupant (the accelerator position, the amount of braking, or the steering angle), and a signal indicating the setting of a vehicle-mounted device. The sensor for sensing motion of the vehicle 1 is, for example, a speed sensor or an acceleration sensor. The sensor for sensing the condition of the interior of the vehicle 1 or an area around the vehicle 1 is, for example, a thermometer, an illuminometer, or a rainfall sensor. The amount of operation of the vehicle 1 by an occupant is, for example, the accelerator position, the amount of braking, or the steering angle. The setting of a vehicle-mounted device is, for example, the temperature setting of an air conditioner, the airflow setting, the open/closed state of a window, and the volume setting of an audio. These signals will be referred to as “vehicle state information,” below. By vehicle state information being inputted, the generation model can refer to the state of the vehicle 1 or a vehicle-mounted device and can therefore generate more appropriate reply information.

The reply generation unit 32 converts the types and signal values of sensor signals included in vehicle state information to a character string, and joins the converted character string to a character string representing an estimation of the feeling (and position information) of each occupant and voice information, thereby generating text data to be inputted into the generation model. Alternatively, the generation model may include an input layer for inputting vehicle state information, separately from a block into which an estimation of the feeling (and position information) of each occupant and voice information is inputted, as in the case where an estimation of the feeling of each occupant is inputted separately from voice information. In this case, only a character string corresponding to an estimation of the feeling (and position information) of each occupant and voice information is inputted into the block closest to the input side of the multiple stacked blocks, and vehicle state information is inputted into the input layer for inputting vehicle state information. The vehicle state information inputted into the input layer is taken in a block having a cross attention mechanism that calculates cross attention of the vehicle state information and output from an upstream block among the multiple stacked blocks included in the generation model. In this case also, a tuning technique such as LoRA may be applied to training of the generation model related to taking in vehicle state information.

In the above-described embodiment or modified examples, a server (not illustrated) that is communicable via a vehicle-mounted wireless communication terminal (not illustrated) may include a generation model and execute the processing of the reply generation unit 32 and the storing processing unit 35 to generate reply information. In this case, the auto reply device 5 generates a query signal including text data representing an estimation of the feeling and position information of each occupant and an utterance, and transmits the generated query signal to the server via the wireless communication terminal. The server generates reply information by inputting the text data included in the received query signal into the generation model, and transmits the generated reply information to the wireless communication terminal of the vehicle 1 from which the query signal is transmitted. In the server, a combination of reply information and input information in a most recent predetermined period may also be inputted into the generation model, as in the above-described modified example. The auto reply device 5 executes the processing of the notification processing unit 33 and the control unit 34 according to reply information received via the wireless communication terminal. According to this modified example, the auto reply device 5 can use a larger generation model for generating reply information than a generation model achieved by vehicle-mounted hardware resources, and can therefore generate more appropriate reply information.

According to another modified example, the processing of the notification processing unit 33 or the control unit 34 may be omitted.

The computer program for achieving the auto reply process of the above-described embodiment or modified examples may be provided, for example, in a form recorded on a computer-readable portable storage medium as a computer program product.

As described above, those skilled in the art may make various modifications according to embodiments within the scope of the present invention.

What is claimed is:

1. An auto reply device comprising:
a processor configured to:
estimate a feeling of each of occupants of a vehicle, based on an interior sensor signal obtained by a vehicle interior sensor configured to sense a condition of the interior of the vehicle, and
generate reply information to an utterance of one of the occupants by inputting an estimation of the feeling of each occupant and voice information representing the utterance into a generation model that is pre-trained to generate the reply information.

2. The auto reply device according to claim 1, wherein the processor generates the reply information by inputting, for each occupant, an estimation of the feeling of the occupant into the generation model, together with position information indicating the position of the occupant.

3. The auto reply device according to claim 1, wherein the processor is further configured to store a combination of the reply information, an estimation of the feeling of each occupant and the voice information inputted into the generation model at generation of the reply information in a memory, every time the reply information is generated, wherein
the processor generates the reply information by further inputting the combination stored in the memory in a most recent predetermined period into the generation model.

4. An auto reply method comprising:
estimating a feeling of each of occupants of a vehicle, based on an interior sensor signal obtained by a vehicle interior sensor configured to sense a condition of the interior of the vehicle; and
generating reply information to an utterance of one of the occupants by inputting an estimation of the feeling of each occupant and voice information representing the utterance into a generation model that is pre-trained to generate the reply information.

5. A non-transitory recording medium that stores a computer program for auto reply, the computer program causing a computer to execute a process comprising:
estimating a feeling of each of occupants of a vehicle, based on an interior sensor signal obtained by a vehicle interior sensor configured to sense a condition of the interior of the vehicle; and
generating reply information to an utterance of one of the occupants by inputting an estimation of the feeling of each occupant and voice information representing the utterance into a generation model that is pre-trained to generate the reply information.
